(19) United States
(12) Patent Application Publication
(10) Pub. No.: US 2006/0178957 A1
(43) Pub. Date: Aug. 10, 2006

(54) Commercial market determination and forecasting system and method

(75) Inventor: Justin LeClaire, Pleasanton, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Visa U.S.A., San Francisco, CA (US)

(21) Appl. No.: 11/054,772

(22) Filed: Feb. 9, 2005

Related U.S. Application Data
(60) Provisional application No. 60/645,092, filed on Jan. 18, 2005.

(51) Int. Cl. G07F 19/00

(52) U.S. Cl. 705/30

(57) ABSTRACT

Methods and apparatus for determining a value of a commercial market that can be supported by an electronic payment solution, forecasting a growth of the commercial market, and using the commercial expenditure value are disclosed. The value of the commercial market can be estimated using auditable economic data that forms part of a Gross Domestic Product (GDP) calculation. The commercial market can be estimated using intermediate inputs, inventory purchase, private fixed investments, and government expenditures. A market growth can then be estimated from the commercial expenditure value and other economic data. The commercial expenditure value can be used in a number of resource allocation and market solution processes.

### CROSS-REFERENCES TO RELATED APPLICATIONS

This application claims the benefit of U.S. Provisional Application No. 60/645,092, filed Jan. 18, 2005, entitled “COMMERCIAL MARKET DETERMINATION AND FORECASTING SYSTEM AND METHODS,” hereby incorporated herein by reference in its entirety.

### BACKGROUND OF THE INVENTION

Embodiments of the invention generally relate to methods for determining, forecasting, or using a commercial expenditure value.

A variety of payment solutions exist. For example, simple purchases of goods or services can be paid for using cash, check, wire transfer, credit card, debit card, or some other payment solution.

A “PCE” value or personal consumption expenditure value is often used by a financial services organization such as credit card association to forecast consumer spending. “PCE” can be defined as the aggregate amount spent each year by consumers to buy goods and services from the marketplace. This value permits the organization to determine, how its business might grow over time. Using this information, the organization can make budgeting decisions, determine how to allocate resources, etc.

There is currently no analogous metric to measure commercial consumption expenditures by commercial organizations. It would be desirable to provide a metric or value that informs a financial services organization about the potential opportunity for services such as electronic payment services. For example, a restaurant owner may use a check to purchase supplies for his restaurant. This presents a potential opportunity for the financial services organization to market its services to the restaurant owner. Instead of using a check, the restaurant owner could use a commercial credit card to purchase the supplies from a restaurant equipment supplier, thus avoiding much of the high cost of processing checks, and benefiting from the financial management advantages offered through the reporting capabilities of commercial credit cards. If the financial services organization is successful in convincing the supplier to use a commercial credit card, the financial services organization can thereafter obtain revenue from the restaurant owner's use of the credit card. Because of opportunities like this, financial services organizations want to better understand how large potential market segments are for its services.

Embodiments of the invention address the above problem and other problems, individually and collectively.

### BRIEF SUMMARY OF THE INVENTION

Methods and apparatuses for determining a value of a commercial market that can be supported by an electronic payment solution, forecasting a growth of the commercial market, and using the commercial expenditure value are disclosed. The commercial expenditure value can represent an available market share opportunity for commercial electronic payment solutions.

The value of the commercial market can be estimated using auditable economic data that form part of a Gross Domestic Product (GDP) calculation. The commercial market can be estimated using intermediate inputs, inventory purchase, private fixed investments, and government expenditures. A market growth can then be estimated from the commercial expenditure value and other economic data. The commercial expenditure value can be used in a number of resource allocation and market solution processes.

An aspect of the invention includes a method of determining a commercial expenditure value. The method includes obtaining an intermediate inputs value, obtaining a commercial inventory purchase value, and determining the commercial expenditure value using the intermediate inputs value and the commercial inventory purchase value.

Another aspect of the invention includes a method of determining a commercial expenditure value. The method includes obtaining an intermediate inputs value based on data from one or more Bureau of Economic Analysis (BEA) databases, obtaining a commercial inventory purchase value based on data from one or more Census Bureau databases, obtaining a private fixed investment value based on data selected from one or more BEA gross domestic product (GDP) and National Income and Product Accounts (NIPA) databases, obtaining a government expenditure value based on data selected from one or more BEA GDP and NIPA databases, and determining the commercial expenditure value using the intermediate inputs value, the commercial inventory purchase value, the private fixed investment value, and the government expenditure value.

Another aspect of the invention includes a method of using a commercial expenditure value. The method includes obtaining the commercial expenditure value determined using at least an intermediate inputs value and a commercial inventory purchase value, and forecasting commercial market potential for electronic payment solutions using the commercial expenditure value.

Another aspect of the invention includes a method of using a commercial expenditure value. The method includes obtaining the commercial expenditure value determined using at least an intermediate inputs value and a commercial inventory purchase value, and determining an actionable decision based at least in part on the commercial expenditure value.

Various features and advantages of the invention can be more fully appreciated with reference to the detailed description and accompanying drawings that follow.

### BRIEF DESCRIPTION OF THE DRAWINGS

The features, objects, and advantages of embodiments of the disclosure will become more apparent from the detailed description set forth below when taken in conjunction with the drawings, in which like elements bear like reference numerals.

FIG. 1 is a functional block diagram of an embodiment of a system for determining a commercial expenditure value.

FIG. 2 is a functional block diagram of an embodiment of a computer that can be used in determining, forecasting, and using the commercial expenditure value.

FIG. 3 is an example of a chart illustrating the relative size and market penetration for commercial payment solutions relative to personal payment solutions.

FIGS. 4A-4C are examples of charts illustrating commercial expenditure value segmentation.

FIG. 5 is a functional block diagram of an embodiment of a system for distributing and using a commercial expenditure value.

FIG. 6 is a flowchart of an embodiment of a process for determining a commercial expenditure value.

FIG. 7 is a flowchart of an embodiment of a process of forecasting a commercial expenditure value.

FIG. 8 is a flowchart of an embodiment of a process of using a commercial expenditure value by a solution provider.

FIG. 9 is a flowchart of an embodiment of a process of using a commercial expenditure value by an issuer of payment solutions.

### DETAILED DESCRIPTION OF THE INVENTION

Methods and apparatuses for determining a value of commercial market potential for electronic payment solutions are described. In embodiments of the invention, “a commercial expenditure value” can be determined as an overall, or aggregate commercial expenditure value, which can be segmented to provide additional information of interest. For example, the aggregate commercial expenditure value can be segmented based on industry, spending segment, business size, as well as other segmentation criteria. The commercial expenditure value can also be determined corresponding to a particular period of time. The commercial expenditure value can be updated on a periodic schedule, or can be updated as new economic data becomes available.

The commercial expenditure value can be determined by examining publicly accessible, auditable, databases of economic activity. The basis for determining the commercial expenditure value can originate, for example, within trusted government databases that are established and maintained to track economic data. The specific values from identified databases can be extracted and summed to generate the aggregate commercial expenditure value. Each constituent part of the aggregate commercial expenditure value can be segmented according to one or more segmentation criteria to generate a segmented analysis of the commercial expenditure value.

The commercial expenditure value can be forecasted to illustrate a growth potential for electronic payment solutions. The commercial expenditure value can also be forecasted on the basis of an aggregate commercial expenditure value as well as on the basis of one or more segments from a segmented commercial expenditure value. Economic forecast inputs from a variety of sources can be used to forecast one or more segments in a particular segmented analysis.

Once the commercial expenditure value is determined or otherwise obtained by various entities associated with the supply and implementation of electronic payment solutions, the entities can use the commercial expenditure value to evaluate performance or to make actionable decisions. For example, a provider of one or more electronic payment solutions, such as a provider of credit cards and associated electronic payment solutions, can examine the market penetration achieved by the type of electronic payment solution it provides.

Electronic payment solution issuers, such as banks and other financial institutions that can issue credit cards or issue or conduct other forms of electronic payment solutions for commercial markets, can use the aggregate commercial expenditure value of segmented commercial expenditure value to allocate resource and to determine business opportunities. The issuer can use the information to identify target accounts, focus marketing and advertising plans, and to measure performance. For example, a bank can determine how to allocate resources to entice customers to transition from high expense items such as commercial checks to more efficient payment methods such as commercial credit card payments. By transitioning customers from commercial checks to an electronic payment solution, a bank can minimize the expenses related to processing commercial checks and can even generate revenue when the customer uses an electronic payment solution such as a commercial credit card.

Determining Commercial Expenditure Value

A commercial expenditure value measures and represents a total dollar value of potential payment company commercial volume. The commercial expenditure value captures potential commercial financial transactions that can utilize electronic payment solutions. Such electronic payments solutions may use payment cards, commercial credit cards, small business cards, fleet cards, etc. Other, non-card based electronic payment solutions are offered under the tradename Visa Commerce™.

Presently, there is no analysis in the marketplace that uses documented and verifiable data sources for the generation and determination of the commercial expenditure value. Market analyses can be obtained by hiring market analysts. Unfortunately, the proprietary nature of such analyses substantially limits the ability to audit or independently verify the results of the analyses. The lack of transparency in the manner in which the results of such analyses were obtained, prevents such analyses from being widely adopted. In contrast to such analyses, embodiments of the invention can be determined using entirely publicly available data that is generally considered to be accurate, high quality, and verifiable.

Additionally, the commercial expenditure value takes into account the ability for numerous transactions to occur based on the same, or similar production units. For example, an equipment manufacturer may purchase raw materials and generate a piece of equipment that can be sold to one or more wholesalers as well as to one or more retailers. The wholesalers can sell the same piece of equipment to retailers. Thus, the same product may be sold multiple times (e.g., from the manufacturer, to the wholesaler, and to the retailer). Although a single piece of equipment may be manufactured and sold multiple times, the multiple commercial transactions that can occur each represent a commercial financial transaction that can potentially be serviced with an electronic payment solution. Therefore, the commercial expenditure value takes into account the potential for multiple commercial sales of the same piece of equipment.

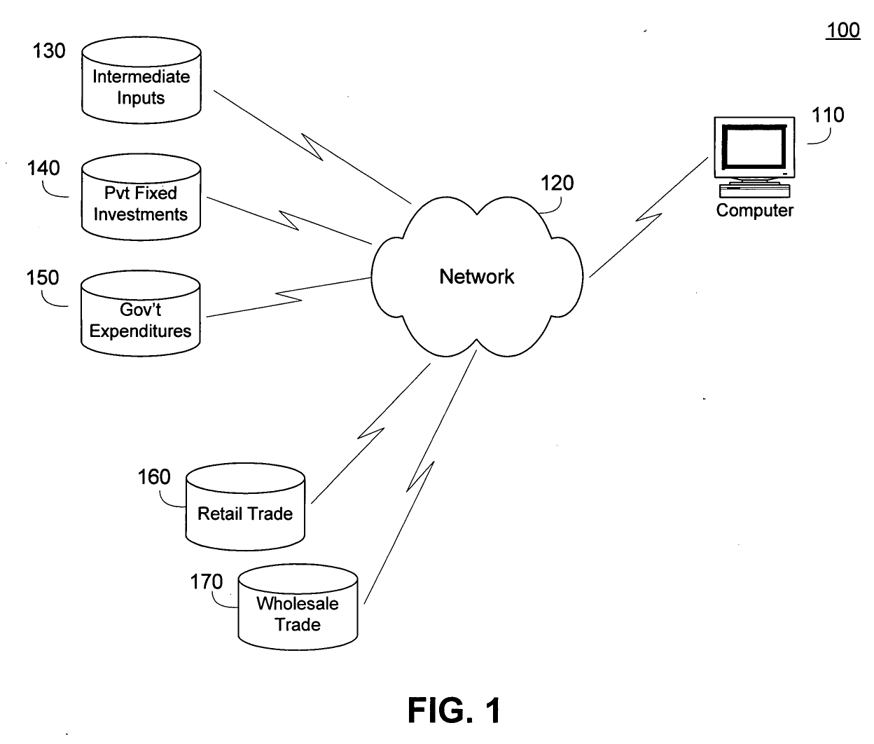

FIG. 1 is a functional block diagram of a system 100 that can be configured to determine or otherwise generate a commercial expenditure value that is verifiable and auditable, and that captures the multiple financial transactions that may occur for the same product. In the system 100 of FIG. 1, the commercial expenditure value is determined based on a methodology that uses four main sources of data, although other embodiments may use greater or fewer sources of data. The four main sources of data include intermediate inputs, inventory purchases, which can include wholesale purchases and retail purchases, private fixed investments, land government expenditures.

The term “intermediate inputs” is an economic term of art that represents the annual dollar amount of business purchases from one business to another. Intermediate inputs captures the money spent by firms to acquire materials or services used in production. This includes most business expenses including payables and COGS (cost of goods sold). However, by definition, intermediate inputs excludes corporate income taxes paid, profits made, salary expenses, and some capitalized expenditures such as buildings, property, etc. Intermediate inputs form a good basis for calculating the commercial expenditure value. The category of intermediate inputs includes items that can be purchased by using an electronic payment solution. However, the category of intermediate inputs does not encompass the types of items for which a payment solution issuer may wish to exclude from payment using an electronic payment solution.

Another component of the commercial expenditure value is inventory purchase. Inventory purchase includes the inventory purchases made from one business to another. Inventory purchases by a retail store are examples of the types of inventory expenses that are not captured by intermediate inputs, but is captured in inventory purchase, because inventory purchase is the type of expense that can be serviced with a payment solution.

Another component of the commercial expenditure value is private fixed investment. As discussed above, intermediate inputs does not include capital expenditures, such as personal computers or office equipment. A significant portion of capital expenditures can be serviced by electronic payment solutions. To capture these purchases, the commercial expenditure value can include select capitalized items made by businesses that are excluded from intermediate inputs. Capitalized purchases that are included as private fixed investment in the determination of commercial expenditure value can include equipment and software, computer terminals, software, communications equipment, photocopy and related office equipment, furniture, and fixtures. However, care should be taken to exclude capitalized purchases or investments that are typically not serviced by payment solutions, such as buildings, aircraft, etc.

Another component of the commercial expenditure value includes government expenditures, where the term “government expenditures” does not represent all government spending, but rather represents those federal, state, and local government expenditures that can be serviced by a payment solution. Intermediate inputs captures a limited segment of government purchases. For example, intermediate inputs includes intermediate inputs from agencies like the U.S. Post Office and state run liquor stores. To account for government purchases that can be serviced by payment solutions, the commercial expenditure value includes items that are considered intermediate inputs in addition to capitalized spending for government expenditures.

Government expenditures can include items for national defense for items like office supplies, petroleum products, food for military personnel, ammunition. Government expenditures can also include various government non-defense spending items that may be limited to the categories that are most amenable to being serviced by a payment solution. Identified categories include vehicle fleets, restaurant/food service equipment, machinery and hospital equipment. Additional other services are included like R&D purchased from contractors, transportation of materials and persons, including travel and entertainment spending, personnel support such as temp agencies or consultants. Items purchased by the government, such as fuel, machinery, on-durable goods, electronic goods, computer servers, desktop applications and software are also included in government expenditures.

The system 100 of FIG. 1 includes a computer 110 that is configured to determine a commercial expenditure value based on input values received, or otherwise accessed or retrieved, from a plurality of remote databases. The computer 110 is not limited to any particular type of computer, but may be a communication device. For example, a communication device can be a server, a computer, a personal computer, a personal digital assistant, a terminal, a special purpose communication device, a telephone, a wireless telephone, and the like, or some other communication device. The computer 110 can be coupled to a network 120 which can include a Wide Area Network (WAN), Local Area Network (LAN), or some other network configuration or combination of network configurations. The network 120 can include, for example, the Internet.

The network 120 is also in coupled to, or otherwise in communication with, various databases that can be used to store the components of commercial expenditure value. In the example of FIG. 1, the computer 110 is configured to determine the commercial expenditure value based on government resources, such as data computed by the Bureau of Economic Analysis (BEA) or the Census Bureau. The use of data and information compiled for government economic analysis provides numerous advantages. Use of the data and information compiled by the government provides a high level of confidence in the data. The data are the best published measures available from recognized government agencies. The data can be government data that is tied to, or integral to, the GDP data. Additionally, the data and information appearing in the government databases are gathered or otherwise derived using established methodology. The transparency of the government data can provide transparency in the determination of the commercial expenditure value. The commercial expenditure value can be independently audited or determined using the same government databases.

For example, the computer 110 can access, via the network 120, a first database 130 containing the intermediate inputs. The first database 130 can be, for example, a BEA database that includes BEA input and output tables. The value of intermediate inputs can be determined by the computer 110, for example, by examining the gross output and Gross Domestic Product (GDP) information stored on the first database 130. In one embodiment, the value of intermediate inputs can be determined as the value of gross output less the value of the GDP (Gross Output—GDP). Here, the value of gross output represents the total dollar amount of final goods and services, along with intermediate purchase transactions made to produce the final good or service. GDP represents the final value of the all final goods produced.

The computer 110 can similarly access, via the network 120, a second database 140 that includes the data relating to private fixed investments. The second database 140 can include, for example BEA databases. For example, the computer 110 can access the BEA GDP National Income and Product Accounts (NIPA) data and can select items from the second database 140 those capitalized items which are typically excluded from intermediate inputs. For example, the computer 110 can select data from the second database 140 based on predetermined list or criteria. For example, the computer 110 can be configured to select from the second database 140 the value corresponding to capitalized items such as equipment and software, including computer terminals, software, communications equipment, photocopy and related office equipment, including furniture and fixtures. The computer 110 can be configured to select those categories of items that are capable of being purchased using an electronic payment solution, such as, but not limited to, a commercial credit card.

The computer 110 can also access, via the network 120, a third database 150 which can contain the data relevant to government expenditures. As noted earlier, government expenditures can be loosely categorized as either defense related spending and non-defense related spending. Data for both categories of government expenditures are available in BEA GDP NIPA tables.

The computer 110 can be configured to select data from the database representing those types of expenditures that are capable of being purchased using an electronic payment solution. For example, the computer 110 can select data from the third database 150 based on predetermined list or criteria.

The criteria for defense related spending can include non-durable goods such as office supplies, petroleum or other fuel products, food for military personnel, and ammunition. Services in defense spending can include R&D purchased from contractors, installation support, transportation of materials and persons, personnel support such as from temporary agencies or consultants. Defense spending can also include gross investments in equipment and software, including electronics goods, computer servers, desktop applications, and other software.

The criteria for non-defense spending can include much the same categories that are included in the defense related spending. These categories can include durable goods, non-durable goods, services, and gross investment in equipment and software.

The computer 110 can access, via the network 120, a fourth database 160 that can store data relevant to retail trade or retail inventory purchases. Similarly, the computer can access, via the network 120, a fifth database 170 that can store data relevant to wholesale trade or wholesale inventory purchases. The computer 110 can retrieve the information from each of the databases to compile the inventory purchases component of the commercial expenditure value.

The computer 110 can access, for example, purchase data supplied on Census Bureau databases. The data can include incremental expenses such as supplies, and Selling, General and Administrative Expenses (SG&A) not typically included in intermediate inputs. The data can also include the inventory purchases such as raw materials and cost of goods sold (COGS), which are also typically excluded from intermediate inputs.

Although accessing of different databases is shown in FIG. 1, it is understood that in other embodiments, all databases could simply reside on the computer 100 without the need to access a network 120. In addition, in other embodiments, the values forming the commercial expenditure value may be obtained manually by looking the values up in a printed medium, and then manipulating those values (e.g., manually or electronically) to determine the commercial expenditure value.

Once the computer 110 has retrieved or otherwise obtained all of the data, the computer 110 can determine the commercial expenditure value based on the sum of the values from the component parts. The computer 110 can generate a report or output of the commercial expenditure value, including the segmented commercial expenditure value explained below. The report or output can be provided or accessed by interested parties that can, in turn, make actionable decisions based on the commercial expenditure value.

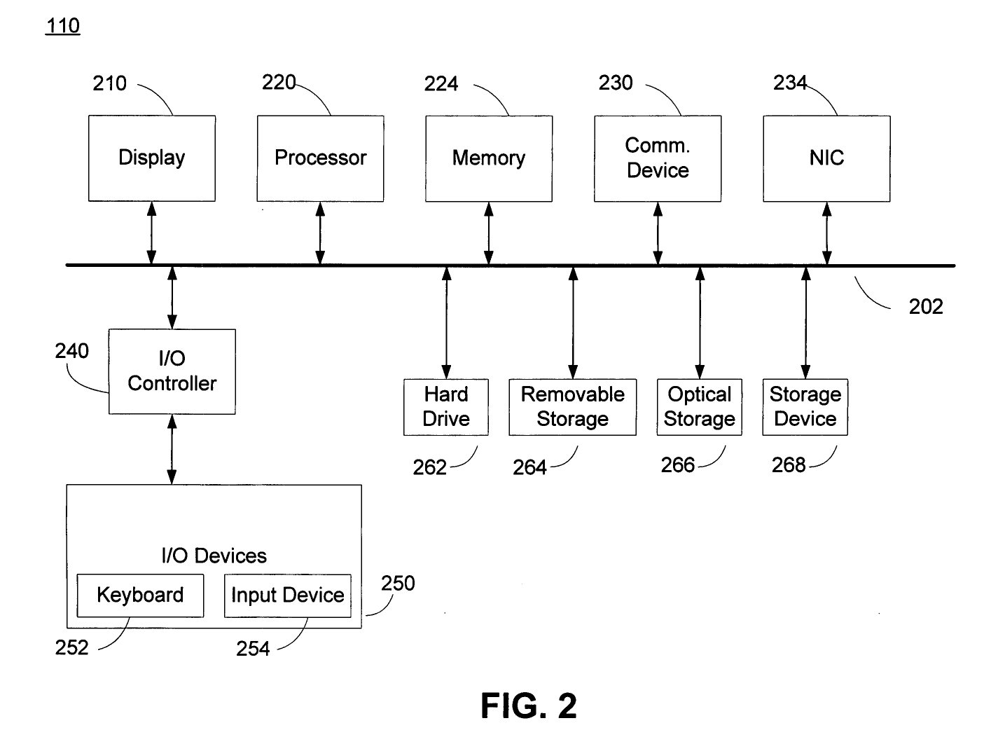

FIG. 2 is a functional block diagram of an example of a computer 110 which can be used in the system 100 of FIG. 1 or in one or more other systems that may appear in subsequent figures.

The computer 110 can include a display 210, a processor 220, memory 224, a communication device 230, a network interface Card (NIC) 234, an I/O controller 240, a hard drive 262, one or more removable storage drives 264, which can include a floppy drive, and an optical storage 266, and one or more storage devices 268. The I/O controller 240 can be configured to interface with one or more I/O devices 250, which can include a keyboard 252 and some other input device 254. The NIC 234 can couple the computer 110 to a network, such as the network shown in FIG. 1.

The various elements within the computer 110 can be coupled using one or more computer busses 202. The one or more storage devices 268 can include, but are not limited to, ROM, RAM, non-volatile RAM, flash memory, magnetic storage, optical storage, tape storage, hard disk storage, and the like, or some other form of processor readable medium.

The memory 224 and the storage devices 268 can include one or more processor readable instructions stored as software. The software can be configured to direct the processor 220 to perform some or all of the functions within the computer 110 within the system 100 of FIG. 1 or in subsequent figures. The software can include stand alone software executed by the processor 220, or the software can run within an operating system or within another software program.

Of course, not every computer 110 includes all of the modules or elements depicted in the embodiment of FIG. 2. Some of the elements can be optional and may be omitted. Other elements not shown can be added to the computer 110.

In one embodiment, the commercial expenditure value determined from the BEA and Census Bureau databases for the year 2003 results in a commercial expenditure value of $13.6 trillion. The commercial expenditure value is composed of approximately 56% attributable to intermediate inputs, 35% attributable to inventory purchases, of which 20% is attributable to retail inventory purchases and 15% is attributable to wholesale inventory purchases, 5% attributable to private fixed investments, and 4% attributable to government expenditures.

In other embodiments, the computer 110 can determine the commercial expenditure value using a subset of the data components discussed above, or can include additional data components. For example, in an embodiment, the computer 110 can determine the commercial expenditure value based on intermediate inputs and inventory purchases, as these two components represent a substantial portion of the potential payment solution market, and may represent that portion of the commercial payment solution market that is most easily targeted for electronic payment solutions.

The commercial expenditure value represents the potential component of the economy that can be serviced by payment solutions, such as electronic payment solutions. As discussed earlier, the payment solutions can include payment cards, commercial cards, small business cards, fleet cards, and electronic payment solutions that do not require cards.

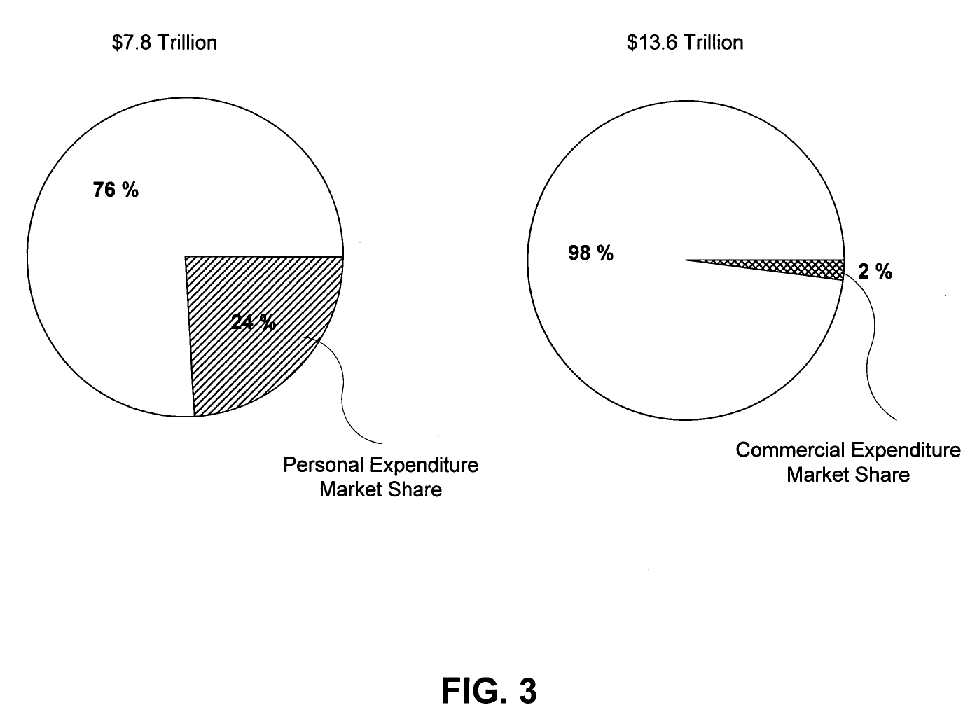

FIG. 3 is a chart of commercial expenditure value and the portion of the commercial expenditure value that is captured by payment solutions. It can be seen from the commercial expenditure value chart that the portion of the total commercial expenditure value that is captured by payment solutions represents only approximately 2.0% of the total potential. For purposes of comparison, a chart showing the value of personal consumption expenditures is shown with the portion captured by personal payment solutions. As can be seen from the chart, payment solutions capture approximately 23.6% of the total potential for personal consumption expenditure. Therefore, a comparison of the two charts would indicate that the penetration of commercial payment solutions lags that of personal payment solutions.

The commercial expenditure value can be of interest to financial services organizations such as credit card organizations, banks, etc. The commercial expenditure value can be generated on a global basis, a per country basis, or for one or more countries or regions for which the economic data exists.

Commercial Expenditure Value Segmentation

The commercial expenditure value for the entire world or an entire country may capture too much information for some analysts. For example, an analyst at a regional credit union that is an issuer of a commercial payment solution, such as a small business credit card, may be interested in a global commercial expenditure value, but a global commercial expenditure value or even a per country commercial expenditure value may not have the level of detail necessary for a regional analyst to make actionable decisions. The analyst can be interested in portions of the commercial expenditure value, such as those portions within a particular geographic region or within a particular industry.

To provide more relevant information to potential analysts, the commercial expenditure value can be segmented to provide additional data. The segmented commercial expenditure value can be of interest to the payment solution providers, and can provide relevant data to the payment solution issuers that is not readily available from the non-segmented or aggregate commercial expenditure value.

The commercial expenditure value can be segmented according to a variety of segmentation criteria to allow for analysis of the commercial expenditure value according to several methodologies. For example, the commercial expenditure value can be segmented by industry, purchase type, business size, major market participants, or some other segmentation criteria.

The payment solution providers as well as the payment solution issuers can use the various segment views to make actionable decisions. For example, the payment solution issuers can use various segment views to target account acquisition, focus marketing and advertising plans, and measure performance.

An industry segmentation of the commercial expenditure value can be used to determine the share of total commercial expenditure value spent according to industry. Examples of industries that can be represented in an industry segmentation include manufacturing, retail trade, wholesale trade, finance insurance and real estate, state and local governments, professional and business services, information, educational service and health care, federal government, construction, arts entertainment and recreation, transportation and warehousing, other non-government services, agriculture, utilities, and mining. It can be advantageous for the segmentation criteria and segmentation categories to be represented in data that is in the same form and accessible from the same databases used to determine the commercial expenditure value.

The various databases, 130, 140, 150, 160 and 170 discussed above that are accessed by the computer 110 may already have data categorized by the various segments. For example, the BEA intermediate inputs first database 130 may already have intermediate inputs for various industry types. The computer 110 can access the various segment categories when determining the aggregate intermediate inputs. Alternatively, the computer 110 can access the various segment categories independent of the aggregate intermediate inputs.

Similarly, the commercial expenditure value can be segmented by purchase or spending type. The various spending type categories that can be included in a spending segmentation include, but are not limited to, core business services, maintenance and operating supplies, raw materials and manufacturing goods, rent, travel and entertainment, capital equipment, and other spending. The various categories can capture spending on such items as office supplies, shipping and overnight delivery, fuel, and rents. As was the case for the industry segmentation, it can be advantageous if the data and databases used by the computer 1 10 in determining the commercial expenditure value is already segmented according to the various categories for the spending segmentation view. Thus, the BEA GDP/NIPA data, as well as the Census Bureau inventory purchase data, may already be segmented according to spending categories.

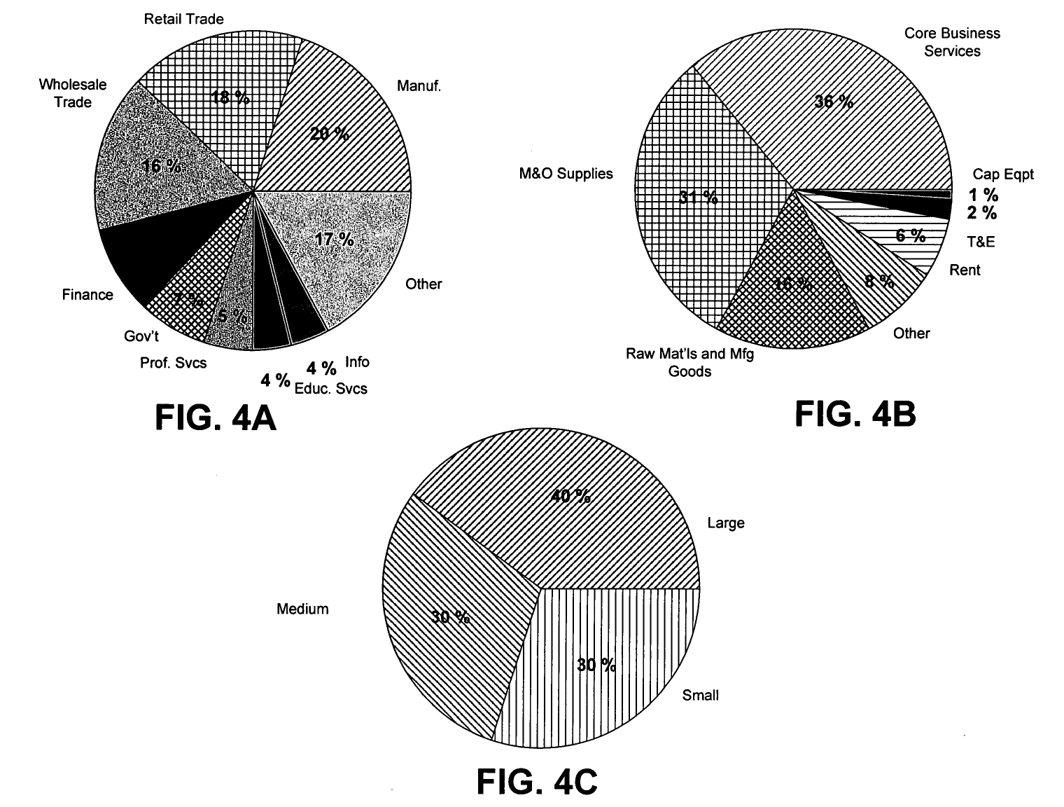

FIGS. 4A-4C show a number of charts illustrating examples of various segmentation views. FIG. 4A is a chart of an example of a industry segmentation view of the commercial expenditure value. The entirety of the circle represents the same commercial expenditure value shown in FIG. 3, however, the different portions represent industry contributions to the total value. Similarly, FIG. 4B is a chart of an example of a spending segmentation view of commercial expenditure value. While the example in FIG. 4B shows only four major segmentation categories, it is understood that more or fewer segmentation categories can be used depending on the desired use of the segmentation view and the corresponding ability to access data corresponding to the desired segmentation view. FIG. 4C is a chart of an example of a business size segmentation view of commercial expenditure value. Again, while only three business sizes are shown in the example of FIG. 4C, any level of granularity can be used in the segmentation view depending on the desired result and the ability to access or generate data representing the segment category.

Using Commercial Expenditure Value

Once the commercial expenditure value and desired segmentation views have been determined or otherwise obtained, any number of applications can use the commercial expenditure value information. The actual application of the commercial expenditure value or of the commercial expenditure value segmentation view can depend on the end user. For example, the payment solution providers will typically have different uses than the payment solution issuers.

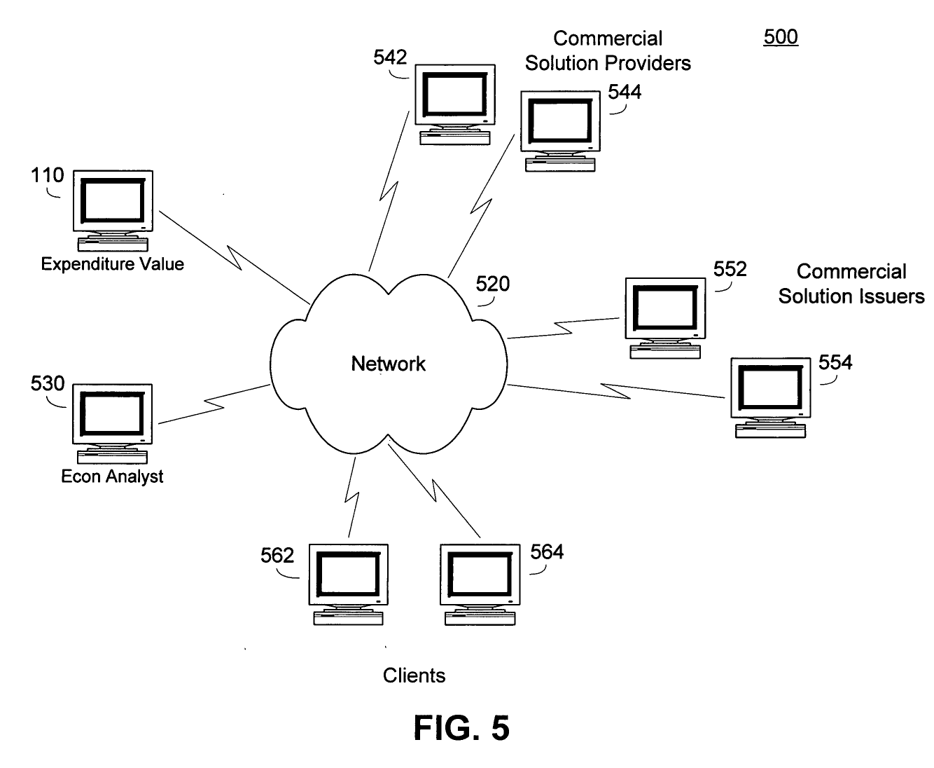

FIG. 5 is a functional block diagram of an embodiment of a system 500 for distribution and use of commercial expenditure value, including the segmented commercial expenditure value. The system 500 includes a computer 110 or other apparatus configured to generate, obtain, calculate, or otherwise determine the commercial expenditure value and one more segmentation views of the commercial expenditure value. The computer 110 can be, for example, the computer of the system shown in FIG. 1. The computer 110 and generally, all of the computers of FIG. 5, can be implemented as shown in FIG. 2.

The computer 110 can be coupled to a network 520. The network 520 can be the same as, or different from, the network shown in FIG. 1. In one embodiment, the network 520 is the Internet. An economic analysis module 530 can be coupled to the network. The economic analysis module 530 can be, for example, a computer at an economic analyst or some other type of economic analysis vendor.

One or more commercial payment solution providers, 542 and 544, can also be coupled to the network 520. Each of the commercial payment solution providers 542 and 544 can include, for example, one or more computers coupled to the network 520. For example, a first payment solution provider 542 can include a plurality of privately networked computers that access the network 520 via one or more access computers. An example of a commercial payment solution provider includes such payment solution providers as Visa or American Express. Although only two payment solution providers 542 and 544 are shown in the system 500 of FIG. 5, other embodiments may include more or fewer commercial payment solution providers. The computer 110 that determines the commercial expenditure value can be, for example, one of the computers of the commercial payment solution providers 542 and 544.

One or more commercial payment solution issuers 552 and 554 can also be coupled to the network 520. Each of the commercial payment solution issuers 552 and 554 can include, for example, one or more computers coupled to the network 520. An example of a commercial payment solution issuer includes such payment solution issuers as banks or credit unions. Although only two payment solution issuers 552 and 554 are shown in the system 500 of FIG. 5, other embodiments may include more or fewer commercial payment solution issuers. In some embodiments, a commercial payment solution provider, for example 542, can also be a commercial payment solution issuer 552 or 554. Also, the computer 110 that determines the commercial expenditure value

One or more commercial clients 562 and 564 can also be coupled to the network 520. As with the other commercial payment solution participants, each of the commercial clients 562 and 564 can include, for example, one or more computers coupled to the network 520. An example of a commercial client includes such payment solution clients as small businesses, service providers, contractors, and consultants. Typically, the number of commercial clients 562 and 564 is much greater than two, although only two are shown in the system 500 for the sake of clarity.

Forecasting Commercial Expenditure Value

One application of the commercial expenditure value and the commercial market segmentation views is the forecasting of growth in the commercial expenditure value, and thus forecasting the growth of the potential for commercial payment solutions. The forecast of commercial expenditure value can be performed, for example, by one or more of the payment solution provider 542 and 544. In other embodiments, the forecast of the commercial expenditure value can be performed by the computer 110 used to determine the commercial expenditure value or by one or more of the commercial payment solution issuers 552 and 554, or one or more of the clients 562 and 564.

In one embodiment where a commercial payment solution provider, for example 542, forecasts the commercial expenditure value, the payment solution provider 542 can initially determine or otherwise obtain the commercial expenditure value. For example, the payment solution provider 542 can obtain the commercial expenditure value from the computer 110. The commercial expenditure value can be in the form of a total or aggregate commercial expenditure value and may also be one or more segmentation views of the commercial expenditure value.

In an embodiment, the payment solution provider 542 can separately forecast the growth rate of each of the component parts of the commercial expenditure value. Thus, the payment solution provider 542 can separately forecast the growth of the intermediate inputs, inventory purchases, private fixed investments, and government expenditures.

In another embodiment, the payment solution provider 542 can separately forecast growth of one or more of the segment categories in a segmentation view of the commercial expenditure value. The payment solution provider 542 can forecast the growth of the segment category as a whole, or can forecast the growth of the segment category by forecasting the growth within each of the component parts of the segment category. For example, a payment solution provider 542 can forecast growth of a particular industry from the industry segmentation view, say manufacturing, by separately forecasting the growth of the intermediate inputs, inventory purchases, private fixed investments, and government expenditures that contribute to the segment category.

In one embodiment, the payment solution provider 542 can purchase or otherwise obtain one or more growth rate forecasts from an economic vendor having an economic analysis module 530. The growth rate forecast can be directed to a particular component of the commercial expenditure value, directed to a particular segment category of a segmentation view, or some combination of component and segment category. For example, a payment solution provider 542 can purchase growth rate forecasts and adjust the values of intermediate inputs and inventory purchase based on the growth forecasts to forecast growth of the commercial expenditure value. The growth of such components as intermediate inputs or private fixed investments can be derived from growth forecasts for other economic measures. For example, an economic analysis module 530 may generate a forecast of the GDP or of gross output. The growth of intermediate inputs or government expenditures may be derived indirectly from such growth forecasts. Other forecasts generated by economic vendors may be much more focused and may be directed to particular segment categories of particular segmentation views. In such a case, it may be more direct for the payment solution provider 542 to forecast growth.

Market Segment Penetration/Performance Analysis

The payment solution providers 542 and 544 as well as the payment solution issuers 552 and 554 can determine market segment penetration based on the commercial expenditure value and the various segmentation views of the commercial expenditure value. A payment solution provider, for example 542, can examine the commercial expenditure value and determine from its internal databases the amount of expenditures that are serviced by the payment solutions that it provides. For example, a payment solution provider 542 can determine the value of expenditures serviced by small business credit cards and other commercial credit cards. The value can be compared against the commercial expenditure value to determine a degree of market segment penetration.

The payment solution provider 542 can perform a more detailed analysis by determining a value of serviced expenditures corresponding to one or more segment categories. The value of serviced expenditures can be compared to the corresponding segment categories to determine a market segment penetration within the segment category. A payment solution issuer, for example, 554, can perform a similar analysis. A payment solution issuer can, for example, allocate funds to promote adoption and use of a payment solution provided by an issuer based on the segmented commercial expenditure value. In another embodiment, the payment solution issuer can assign personnel to programs for promoting adoption of a commercial payment solution, or market to a segment category based at least in part on the segmented commercial expenditure value.

Resource Allocation

A payment solution provider 542 and 544 or a payment solution issuer 552 and 554 can use the commercial expenditure value and the segmented commercial expenditure value to allocate resources. For example, the payment solution provider 542 and 544 or payment solution issuer 552 and 554 can make actionable decisions such as budget allocation to target account acquisition or budget or resource allocation to marketing and advertising.

For example, based on a segmented commercial expenditure value, a payment solution provider 552 or 554 such as a bank can determine that its accounts do not represent the largest participants of commercial expenditure payment solutions. The payment solution issuer, for example 554, can then target one or more clients 562 or 564 for acquisition as a client for a commercial payment solution of a type that it issues.

Additionally, after initially performing market segment performance analysis, a payment solution issuer 552 or 554 can compare the advertising and marketing directed to commercial payment solutions against the advertising and marketing directed to personal payment solutions or other services. The payment solution issuer 552 or 554 can reallocate advertising and marketing resources, whether in terms of budget or personnel, based on the comparison.

As an example, a payment solution issuer, for example 554, can advertise and market commercial accounts that include commercial checking. The same payment solution issuer 554 can also issue one or more payment solutions such as commercial credit cards. The payment solution issuer may determine, based on a comparison of the two solutions, that the commercial credit card solution is more profitable for it, and thus, allocate additional resources to persuading existing clients to transition to electronic payment solutions.

Similarly, a merchant or other commercial enterprise can compare the costs and benefits associated with a paper based purchasing system to the costs and benefits of a purchasing system that incorporates an electronic payment solution such as a commercial credit card. The commercial enterprise can determine that the costs associated with preparing and processing purchase orders are greater than the costs associated with processing payments for a commercial credit card. Additionally, the commercial enterprise can benefit from the purchasing summary that can accompany a typical commercial credit card billing statement. The commercial enterprise can determine that an electronic payment solution is preferable due to lower processing costs and greater visibility to purchases.

The payment solution issuer 554 may determine that it allocates far more resources to targeting commercial checking clients and marketing to commercial checking clients. The payment solution provider can examine a segmented commercial expenditure value to determine the amount of expenditures that a particular segment category spends that can be serviced by a payment solution. The payment solution issuer 554 can allocate additional resources to payment solutions and fewer resources to commercial checking.

Implementation Examples

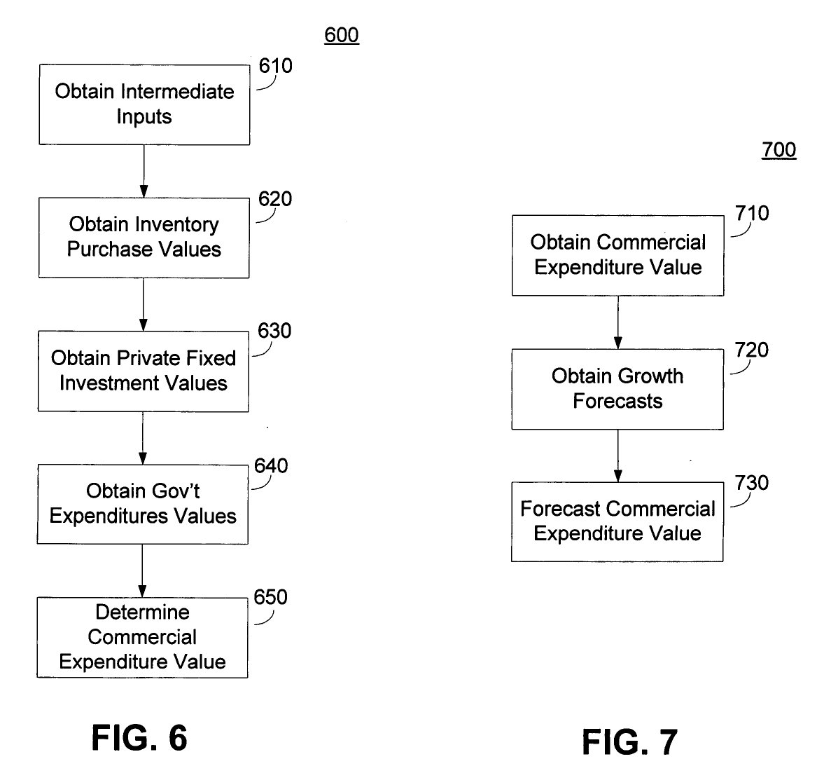

FIG. 6 is a flowchart of an embodiment of a method 600 of determining a commercial expenditure value. The method 600 can be performed, for example, by the computer of FIG. 1 or FIG. 5. The method 600 can also be performed by one or more of the payment solution providers or FIG. 5, as described below. A payment solution provider performing a method, such as the method of FIG. 6 or some other method, may use one or more computers or network of computers to perform some or all of the acts within the method. Some or all of the steps may also be performed manually by a person.

The method 600 begins at block 610 when the payment solution provider retrieves or otherwise obtains values for intermediate inputs. In one embodiment, the payment solution provider can obtain the intermediate inputs directly from a database. In another embodiment, the payment solution provider can access and retrieve associated data and derive the intermediate inputs from the associated data. In a particular embodiment, the payment solution provider can access the BEA GDP/NIPA tables on one or more government databases and can retrieve the intermediate inputs directly from the databases. In another embodiment, the payment solution provider accesses the BEA GDP/NIPA tables to retrieve the gross output and GDP values and determines the intermediate inputs based on the retrieved values. The values retrieved from the databases can be totals or values corresponding to segment categories.

The payment solution provider proceeds to block 620 and retrieves or otherwise obtains inventory purchase values. The payment solution provider can, for example, retrieve retail purchase values and wholesale purchase values from a Census Bureau database having purchase data. As before, the payment solution provider can retrieve totals or values corresponding to segment categories.

The payment solution provider proceeds to block 630 and retrieves or otherwise obtains private fixed investment values. The payment solution provider can, for example, retrieve private fixed investment values from government databases having GDP/NIPA data. The payment solution provider can selectively retrieve data corresponding to one or more predetermined lists of the type of expenditure that can be serviced with a payment solution. As before, the payment solution provider can retrieve totals or values corresponding to segment categories.

The payment solution provider proceeds to block 640 and retrieves or otherwise obtains government expenditure values. The government expenditure data can generally be divided along the lines of defense related expenditures and non-defense expenditures. The payment solution provider can, for example, retrieve government expenditure values from government databases having GDP/NIPA data. The payment solution provider can selectively retrieve data corresponding to one or more predetermined lists of the type of expenditure that can be serviced with a payment solution. For example, the government may procure one or more fighter aircraft but such an expenditure is not typical of one that can be paid for using a payment solution such as a credit card. As before, the payment solution provider can retrieve totals or values corresponding to segment categories.

Once the components of the commercial expenditure value have been obtained, the payment solution provider proceeds to block 650 and determines the commercial expenditure value. The total commercial expenditure value can be determined as the sum of the intermediate inputs, inventory purchases, private fixed investment and government expenditure values.

FIG. 7 is a flowchart of an embodiment of a method 700 of forecasting a commercial expenditure value. The method 700 can be performed, for example, by a payment solution provider, such as one in the system of FIG. 5.

The method 700 begins at block 710 where the payment solution provider obtains the commercial expenditure value. The payment solution provider can obtain the commercial expenditure value from a separate entity that determines the value or can independently determine the commercial expenditure value. The commercial expenditure value can be a total expressed as a single value or can be a segmented commercial expenditure value where the total is broken down into one or more segment categories. Additionally, the payment solution provider can obtain one or more commercial expenditure values for prior periods of time. For example, where the commercial expenditure value can be calculated on an annual basis, the payment solution provider can obtain the commercial expenditure value for the present year as well as for a number of prior years.

The payment solution provider proceeds to block 720 where it obtains one or more growth forecast. The payment solution provider can independently generate growth forecasts based on independent economic analysis or can purchase growth forecasts from one or more economic vendors. The growth forecasts can, but need not, align exactly with segment categories. For example, an economic forecast purchased from an economic vendor can be a forecast of an aggregate of a plurality of segment categories. In another embodiment, the economic forecast can be related to one or more segment categories and the payment solution provider can derive or otherwise extract a desired economic forecast from the purchased economic forecast. The payment solution provider may have previously obtained, or may presently obtain, historical economic forecast data. The prior economic forecast data may correspond to the prior years for which commercial expenditure values are available.

The payment solution provider proceeds to block 730 and forecasts the commercial expenditure value based on the present value and the one or more economic forecasts. Additionally, the payment solution provider can adjust the economic forecast based on the relationship between economic forecasts from prior years and the resulting commercial expenditure value for the subsequent year. The payment solution provider can forecast, for example, a growth of the commercial expenditure value or growth of a segment category within a particular segmented commercial expenditure value.

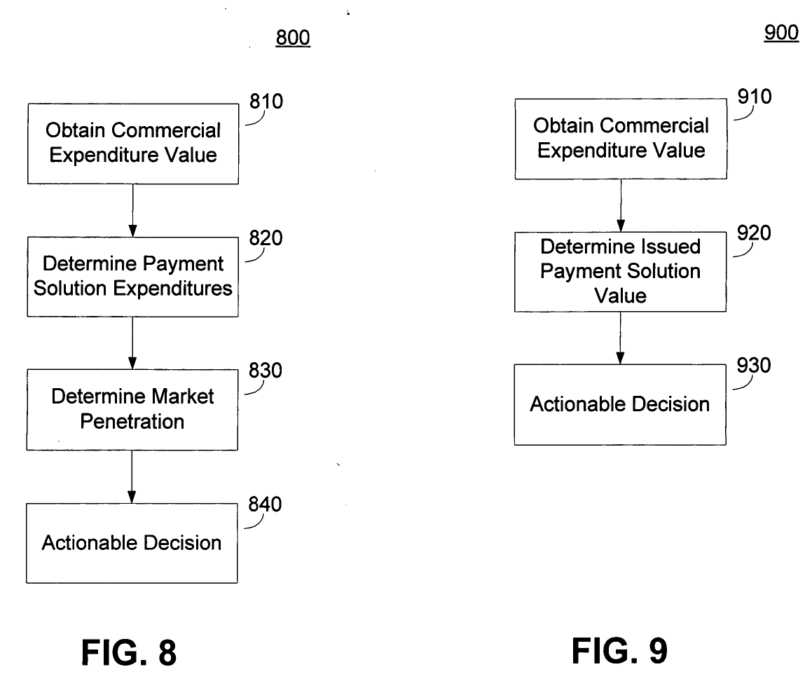

FIG. 8 is a flowchart of an embodiment of a method 800 of using a commercial expenditure value by a commercial payment solution provider. In the method 800 of FIG. 8, the payment solution provider measures a performance or market segment penetration of the types of commercial payment solutions it provides.

The method 800 begins at block 810 where the payment solution provider obtains the commercial expenditure value. As before, the payment solution provider can obtain the commercial expenditure value from a separate entity that determines the value or can independently determine the commercial expenditure value. The commercial expenditure value can be a total expressed as a single value or can be a segmented commercial expenditure value where the total is broken down into one or more segment categories.

The payment solution provider proceeds to block 820 and determines a value of commercial expenditures serviced. That is, of the type of expenditures that qualify for commercial expenditure value, the payment solution provider determines those expenditures that were paid for using a payment solution provided by the payment solution provider.

The payment solution provider proceeds to block 830 and determines market segment penetration based on the value of commercial expenditures serviced and the commercial expenditure value. As before, the market segment penetration can be determined on the basis of the total commercial expenditure value or on segment categories within the commercial expenditure value.

The payment solution provider proceeds to block 840 and can make an actionable decision based on the market segment penetration. For example, the payment solution provider can determine the commercial market segment penetration as discussed above and can determine a similar market segment penetration for personal expenditure payment solutions. If the market segment penetration in one market segment is substantially different from the market segment penetration in the other market segment, the payment solution provider can reallocate resources, which can include budget, personnel, advertising, and marketing, to target the underperforming market segment.

FIG. 9 is a flowchart of an embodiment of a method 900 of using a commercial expenditure value by an issuer of commercial payment solutions, such as the commercial payment solution issuer of FIG. 5. The commercial payment solution issuer can use one or more computers or network of computers to perform one or more acts of the method 900.

The method 900 begins at block 910 where the commercial payment solution issuer obtains the commercial expenditure value. As before, the commercial payment solution issuer can obtain the commercial expenditure value from a separate entity that determines the value or can independently determine the commercial expenditure value. The commercial expenditure value can be a total expressed as a single value or can be a segmented commercial expenditure value where the total is broken down into one or more segment categories.

The commercial payment solution issuer proceeds to block 920 and determines a value of commercial expenditures serviced by payment solutions that it issues. As an example, a bank may access databases of commercial payment cards that it issues and determine the total expenditure values for the cards over the same period of time for which the commercial expenditure value was determined. The commercial payment solution issuer can determine the expenditure value for cards it issued as a total aggregate value or according to one or more segment categories. Thus, for an industry segmentation, the commercial payment solution issuer can determine the value of expenditures for payment cards that it issues to manufacturing clients and can separately determine the value of expenditures for payment cards that it issues to professional business services clients.

The commercial payment solution issuer proceeds to block 930 and makes an actionable decision based on the commercial expenditure value corresponding to a predetermined time period and the value of expenditures for payment solutions that it issues for the same time period. The commercial payment solution issuer can, for example, can reallocate resources, which can include budget, personnel, advertising, and marketing, to target the underperforming segment. Additionally, one can reallocate resources, which can include budget, personnel, advertising, and marketing, to target the underperforming market segment can target one or more segments or one or more potential clients within identified segments for acquisition as a client.

Conclusion

A method and apparatus of determining a commercial market value and segmented commercial market value have been disclosed. The commercial market value can be determined on the basis of government economic data that is established and used for determining the GDP, and thus has a high degree of confidence. The commercial market value and the various segmented commercial market value can be generated and output as a report or some other output. The report may be printed or displayed on a computer screen.

One or more market participants in the commercial payment solution market segment can use the commercial expenditure value and the various segmentations of the commercial expenditure value to make actionable decisions. The commercial expenditure value can be used to determine a market segment penetration for various payment solutions offered by a payment solution provider. The payment solution providers can also use the data to make such actionable decisions as resource allocation. Additionally, one or more segmentation views can be used by a commercial payment solution issuer to determine actionable decisions, such as resource allocation, advertising and marketing, personnel assignments, client targeting, and other decisions.

The steps of a method, process, or algorithm described in connection with the embodiments disclosed herein may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The above description of the disclosed embodiments is provided to enable any person of ordinary skill in the art to make or use the disclosure. Various modifications to these embodiments will be readily apparent to those of ordinary skill in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

What is claimed is:

1. A method of determining a commercial expenditure value, the method comprising:
obtaining an intermediate inputs value;
obtaining a commercial inventory purchase value; and
determining the commercial expenditure value using the intermediate inputs value and the commercial inventory purchase value.

2. The method of claim 1, wherein the commercial inventory purchase value comprises retail inventory purchase value and a wholesale inventory purchase value.

3. The method of claim 1, wherein determining the commercial expenditure value includes summing the intermediate inputs value with the commercial inventory purchase value and a private fixed investment value and a government expenditure value.

4. The method of claim 1, wherein determining the intermediate inputs value comprises extracting a value of intermediate inputs from a Bureau of Economic Analysis (BEA) database.

5. The method of claim 1, wherein determining the intermediate inputs value comprises:
obtaining a gross output value from a Bureau of Economic Analysis (BEA) database;
obtaining a gross domestic product (GDP) value from the BEA database; and
determining the intermediate inputs value based on the gross output value and the GDP value.

6. The method of claim 1 wherein obtaining the commercial inventory purchase value comprises:
obtaining a retail trade purchase value from a Census Bureau database;
obtaining a wholesale trade purchase value from the Census Bureau database; and
determining the commercial inventory purchase value based on the retail trade purchase value and the wholesale trade purchase value.

7. The method of claim 1, further comprising:
obtaining a private fixed investment value;
obtaining a government expenditure value; and
wherein determining the commercial expenditure value comprises determining the commercial expenditure value using the intermediate inputs value, the commercial inventory purchase value, the private fixed investment value, and the government expenditure value.

8. The method of claim 1, wherein the commercial expenditure value comprises a segmented commercial expenditure value.

9. The method of claim 8, wherein the segmented commercial expenditure value is segmented according to a segmentation selected from the group comprising industry, purchase type, and business size.

10. The method of claim 1, further comprising:
generating a report having the commercial expenditure value; and
displaying the report.

11. A method of determining a commercial expenditure value, the method comprising:
obtaining an intermediate inputs value based on data from one or more Bureau of Economic Analysis (BEA) databases;
obtaining a commercial inventory purchase value based on data from one or more Census Bureau databases;
obtaining a private fixed investment value based on data selected from one or more BEA gross domestic product (GDP) and National Income and Product Accounts (NIPA) databases;
obtaining a government expenditure value based on data selected from one or more BEA GDP and NIPA databases; and
determining the commercial expenditure value using the intermediate inputs value, the commercial inventory purchase value, the private fixed investment value, and the government expenditure value.

12. The method of claim 11, further comprising generating a report for one or more payment solution issuers including the commercial expenditure value.

13. A method of using a commercial expenditure value, the method comprising:
obtaining the commercial expenditure value determined using at least an intermediate inputs value and a commercial inventory purchase value; and
forecasting commercial market potential for electronic payment solutions using the commercial expenditure value.

14. The method of claim 13, wherein forecasting commercial market potential comprises:
obtaining a growth forecast; and
projecting a growth of the commercial expenditure value using the growth forecast.

15. The method of claim 13, wherein obtaining the growth forecast comprises obtaining the growth forecast for at least a component of the commercial expenditure value from an economic vendor.

16. The method of claim 13, wherein forecasting commercial market potential comprises forecasting a growth of a segment category within a segmented commercial expenditure value.

17. A method of using a commercial expenditure value, the method comprising:
obtaining the commercial expenditure value determined using at least an intermediate inputs value and a commercial inventory purchase value; and
determining an actionable decision based at least in part on the commercial expenditure value.

18. The method of claim 17, wherein determining the actionable decision comprises:
determining a market penetration based on the commercial expenditure value; and
allocating resources based in part on the market penetration.

19. The method of claim 17, wherein determining the actionable decision comprises:
determining a value of expenditures for commercial payment solutions from an issuer; and
determining, based on the value of expenditures from the issuer, a resource allocation for at least one action selected from the group comprising a budget allocation, a personnel allocation, an advertising resource allocation, and a marketing resource allocation.

20. The method of claim 17, wherein determining the actionable decision comprises targeting at least one business in a segment category of the commercial expenditure value as a client.

21. The method of claim 17, wherein determining the actionable decision comprises allocating funds to promote adoption and use of a payment solution provided by an issuer.

22. The method of claim 17, wherein determining the actionable decision comprises assigning personnel to programs for promoting adoption of a commercial payment solution.

23. The method of claim 17, wherein determining the actionable decision comprises marketing to a segment category based at least in part on a segmented commercial expenditure value.

24. One or more processor readable storage devices containing one or more processor usable instructions, when executed by one or more processors, performing the method comprising:
obtaining an intermediate inputs value;
obtaining a commercial inventory purchase value; and
determining the commercial expenditure value using the intermediate inputs value and the commercial inventory purchase value.

25. One or more processor readable storage devices containing one or more processor usable instructions, when executed by one or more processors, performing the method comprising:
obtaining the commercial expenditure value determined using at least an intermediate inputs value and a commercial inventory purchase value; and
determining an actionable decision based at least in part on the commercial expenditure value.
